(19) United States
(12) Patent Application Publication
(10) Pub. No.: US 2010/0206077 A1
(43) Pub. Date: Aug. 19, 2010

(54) Magnetic Coupler for Isolating Noise and Vibration Transmitted from a Drive Source on a Six-Axles CNC Hybrid Gearset Testing Machine

(76) Inventors: San-Ming Huang, Miaoli (TW); Cheng-Kuo Sung, Hsinchu (TW); Zhang-Hua Fong, Chia-Yi (TW); Chih-Chun Cheng, Chia-Yi (TW); Meng-Shiun Tsai, Chia-Yi (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/371,967

(22) Filed: Feb. 17, 2009

(51) Int. Cl. G01H 17/00

(52) U.S. Cl. 73/570

(57) ABSTRACT

A magnetic coupler for isolating noise and vibration transmitted from a drive source on a six-axles CNC gearset testing machine used to test degrees of noise and vibration is provided. The magnetic coupler for isolating noise and vibration transmitted from a drive source on a six-axles CNC gearset testing machine includes a drive source, a drive shaft, a transmission member for operatively interconnecting the drive shaft and the drive source, and a gearbox having an input shaft; a magnetic coupler comprising an outer cylinder and an inner cylinder adapted to dispose in the outer cylinder and space therefrom; a first chuck adapted to couple the inner cylinder and the input shaft of the gearbox to be tested together, and a second chuck adapted to couple the outer cylinder and the drive shaft together. From the above, noise and vibration would not transmitted from the drive source to the gearbox (e.g., motorcycle gearbox) during the test.

### BACKGROUND OF THE INVENTION

1. Field of Invention

The invention relates to gearbox test apparatuses and more particularly to a magnetic coupler for isolating noise and vibration transmitted from a drive source on a six-axles CNC (computer numerical control) hybrid gearset testing machine.

2. Description of Related Art

Typically, a number of items including noise and vibration are required to be tested in QC (quality control) of a product (e.g., gearbox of a motorcycle) being manufactured. Traditionally, a coupler is mechanically interconnected the gearbox and a drive source. Then, a motor of a test apparatus (i.e., drive source) is activated to rotate a drive shaft, and power is transmitted to the gearbox in the noise and vibration test operation.

However, a couple of drawbacks have been found in the typical noise and vibration test. For example, noise and vibration of the drive source can be transmitted to the gearbox via the magnetic coupler because the magnetic coupler is mechanically interconnected the gearbox and the drive source, so that the noise and vibration of the gearbox are greatly increased. As a result, the actual degrees of vibration and noise of the gearbox cannot be accurately measured. Thus, the need for improvement still exists.

### SUMMARY OF THE INVENTION

It is therefore one object of the invention to provide a magnetic coupler for isolating noise and vibration transmitted from a drive source on a six-axles CNC hybrid gearset testing machine.

For achieving the above, the invention provides the magnetic coupler for isolating noise and vibration transmitted from a drive source on a six-axles CNC gearset testing machine used to test degrees of noise and vibration, wherein the gearset may be a gearbox having an input shaft; the testing machine comprising a drive source, a drive shaft, and a transmission member for operatively interconnecting the drive shaft and the drive source; and a magnetic coupler comprising an outer cylinder and an inner cylinder adapted to dispose in the outer cylinder and space therefrom; a first chuck adapted to couple the inner cylinder and the input shaft of the gearbox, and a second chuck adapted to couple the outer cylinder and the drive shaft together.

The features and advantages of the invention will become apparent from the following detailed description taken with the accompanying drawings.

### BRIEF DESCRIPTION OF THE DRAWINGS

FIG. 1 is a perspective view of a drive source for a vibration test apparatus according to the invention;

FIG. 2 is a sectional view of the drive source;

FIG. 3 is a schematic side elevation in part section of the drive source, a coupler, and a gearbox being coupled together prior to vibration test; and

FIG. 4 is an enlarged view of the coupler of FIG. 3.

### DETAILED DESCRIPTION OF THE INVENTION

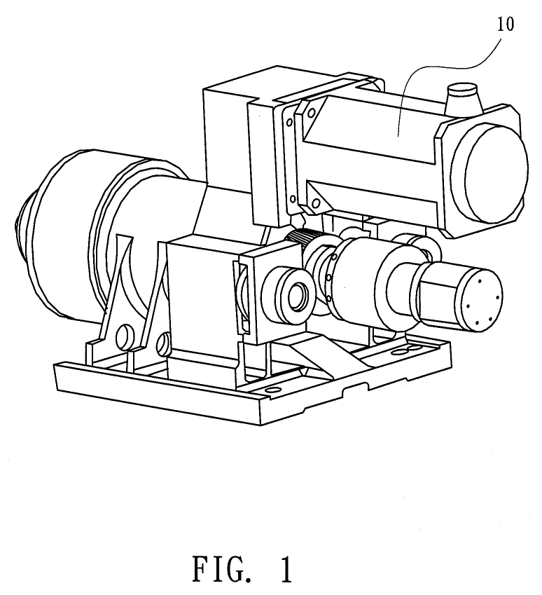

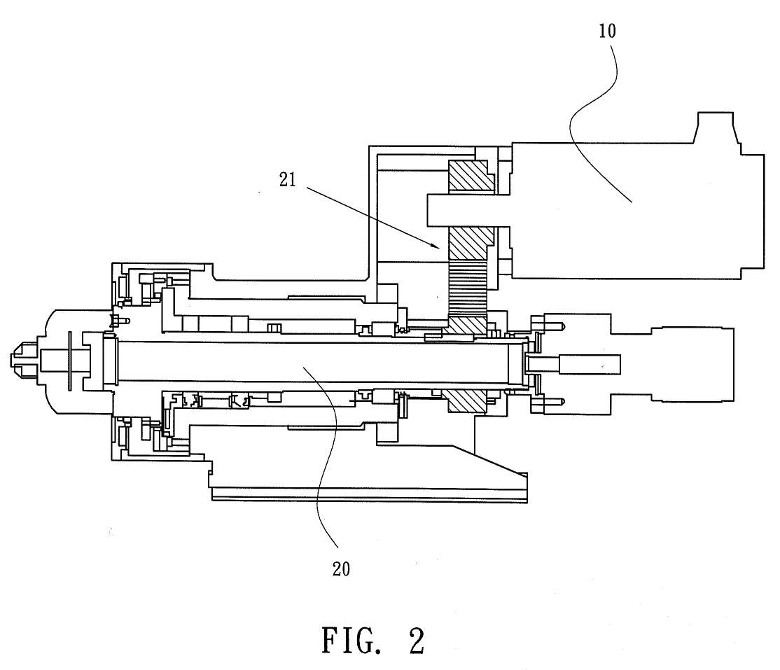

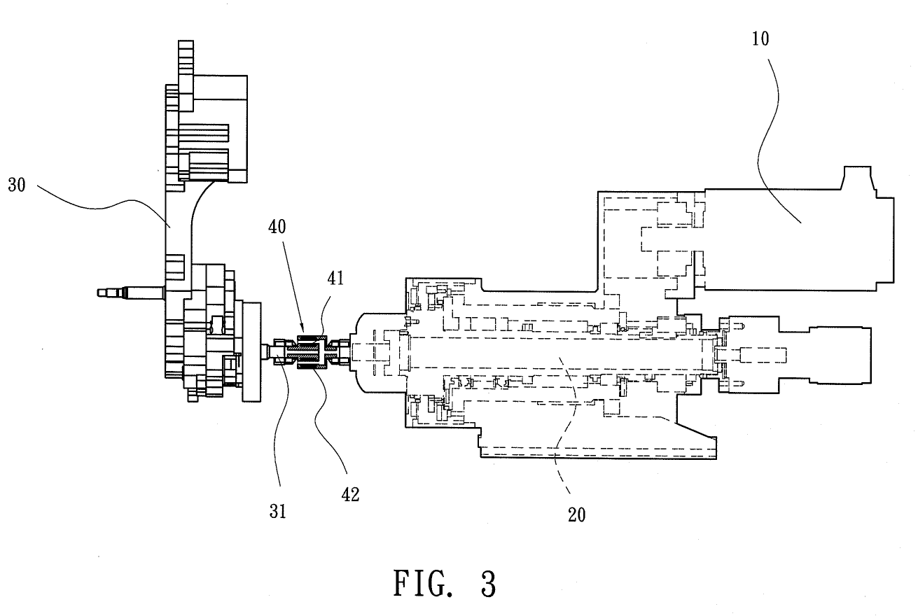

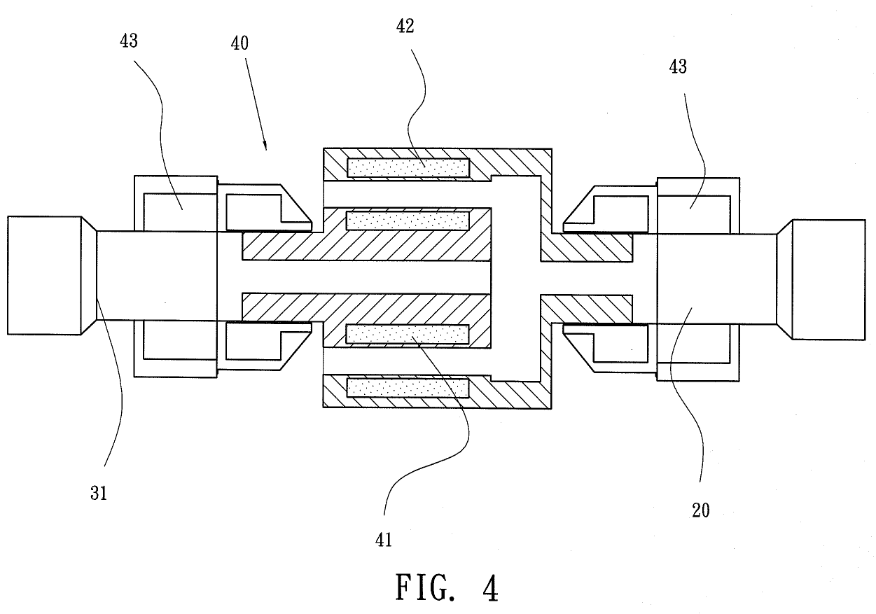

Referring to FIGS. 1 to 4, a magnetic coupler for isolating noise and vibration transmitted from a drive source on a hybrid gearset testing machine used to test degrees of noise and vibration in accordance with the invention is shown. The invention comprises the following components as discussed in detail below.

A drive source 10 such as a motor is provided.

A drive shaft 20 is rotatably connected to the drive source 10 by means of a transmission member 21 such as a combination of two sprockets and a chain.

A gearbox 30 (e.g., motorcycle gearbox) is tested by a six-axles CNC hybrid gearset testing machine. The gearbox 30 has an input shaft 31.

A coupler 40 such as a magnetic coupler is provided. Further, the magnetic coupler 40 is implemented as a radial or axial magnetic coupler. The coupler 40 comprises an outer cylinder 42 and an inner cylinder 41 disposed in the outer cylinder 42 and spaced therefrom (i.e., being not engaged), and two chucks 43 in which one is for coupling the inner cylinder 41 and the input shaft 31 together, and the other is for coupling the outer cylinder 42 and the drive shaft 20 together. The more of the portion of the inner cylinder 41 in the outer cylinder 42 the larger of torque transmitted from the outer cylinder 42 to the inner cylinder 41 will be (i.e., from the drive source 10 to the gearbox 30). To the contrary, the less of the portion of the inner cylinder 41 in the outer cylinder 42 the smaller of torque transmitted from the outer cylinder 42 to the inner cylinder 41 will be.

Noise and vibration test of the invention will be described in detail below. First, couple the inner cylinder 41 and the input shaft 31 together by means of one chuck 43; couple the outer cylinder 42 and the drive shaft 20 together by means of the other chuck 43. Second, move the drive source 10 along a tool path until the outer cylinder 42 and the inner cylinder 41 are magnetically coupled together (i.e., not mechanically contacted). Third, activate the drive source 10 to transmit power to the gearbox 30 for testing noise and vibration degree of the gearbox 30 via the above coupling. After finishing the noise and vibration test, the drive source 10 can be separated from the gearbox 30 along the tool path in an opposite direction.

Advantages of the invention are detailed below. Vibration and noise generated from the drive source 10 is isolated from being transmitted to the gearbox 30 since the coupling therebetween is a non-contact magnetic coupler. From the above, noise and vibration data of the gearbox 30 collected from the test is much precise and further, a user may make a proper adjustment of the gearbox according to the precise testing result.

While the invention herein disclosed has been described by means of specific embodiments, numerous modifications and variations could be made thereto by those skilled in the art without departing from the scope and spirit of the invention set forth in the claims.

What is claimed is:

1. A magnetic coupler for isolating noise and vibration transmitted from a drive source on a six-axles CNC gearset testing machine used to test degrees of noise and vibration comprising:
a drive source;
a drive shaft;
a transmission member for operatively interconnecting the drive shaft and the drive source;
a gearbox, having an input shaft; and
a magnetic coupler comprising an outer cylinder and an inner cylinder adapted to dispose in the outer cylinder and space therefrom; a first chuck adapted to couple the inner cylinder and the input shaft of the gearbox to be tested together, and a second chuck adapted to couple the outer cylinder and the drive shaft together.

2. The magnetic coupler for isolating noise and vibration transmitted from a drive source on a six-axles CNC gearset testing machine used to test noise and vibration of claim 1, wherein the drive source is a motor.

3. The magnetic coupler for isolating noise and vibration transmitted from a drive source on a six-axles CNC gearset testing machine used to test noise and vibration of claim 1, wherein the transmission member is a combination of two sprockets and a chain.

4. The magnetic coupler for isolating noise and vibration transmitted from a drive source on a six-axles CNC gearset testing machine used to test noise and vibration of claim 1, wherein the magnetic coupler is an axial magnetic coupler.

5. The magnetic coupler for isolating noise and vibration transmitted from a drive source on a six-axles CNC gearset testing machine used to test noise and vibration of claim 1, wherein the magnetic coupler is a radial magnetic coupler.
